(19) United States
(12) Patent Application Publication
(10) Pub. No.: US 2011/0309987 A1
(43) Pub. Date: Dec. 22, 2011

(54) REFLECTOR ANTENNA INCLUDING RADOME

(75) Inventors: Ovadia HALUBA, RaAnana (IL); Yigal Leiba, Holon (IL)

(73) Assignee: Siklu Communication Ltd., Petach-Tikva (IL)

(21) Appl. No.: 12/819,206

(22) Filed: Jun. 20, 2010

(51) Int. Cl. H01Q 19/10; H01P 11/00; H01Q 19/06; H01Q 13/00; H01Q 1/42

(52) U.S. Cl. 343/755; 343/781 CA; 343/872; 29/600

(57) ABSTRACT

A radome comprises a structure covering an antenna, the structure being substantially transparent to radiation of the antenna in a first direction and being less transparent to radiation of the antenna when deviating from the first direction, thereby imparting a directional profile to radiation of the antenna. The millimeter wave antenna structure comprises a sub-reflector lens, and a reflector, the sub-reflector lens in turn comprising a reflecting metal plate and a lens shaped dielectric material, the lens shaped dielectric material and the reflecting metal plate being shaped together to provide a predetermined radiation illumination pattern on the reflector. A waveguide matching holder connects a circular cross section waveguide via a circular cavity, and a rectangular waveguide feed via a rectangular cavity, the rectangular and the circular cavities being shaped to merge into each other.

### FIELD AND BACKGROUND OF THE INVENTION

The present invention relates to a reflector antenna, and/or an associated radome and, more particularly, but not exclusively to such an antenna for millimeter wavelengths.

In millimeter wave antenna design one of the issues that is encountered is how to couple energy from a rectangular waveguide to a circular antenna while maintaining high efficiency and suppressing cross-polarization products.

In addition millimeter wave antenna design raises issues of manufacturing cost since the tolerances required are beyond those available from the cheaper mass production techniques.

Furthermore regulations require a certain directivity profile of the beam so as to suppress unwanted interference.

Antennas often include a radome. A radome (a portmanteau of the words radar and dome) is a structure that forms a weatherproof enclosure that protects a microwave or radar antenna. The radome is constructed of material that minimally attenuates the electromagnetic signal transmitted or received by the antenna. In other words, the radome is as close as possible to transparent to radar or radio waves. Radomes generally protect the antenna surfaces from the environment (e.g., wind, rain, ice, sand, ultraviolet rays, etc.) and/or conceal antenna electronic equipment from public view, without affecting the function of the antenna.

Radomes can be constructed in several shapes (spherical, geodesic, planar, etc.) depending upon the particular application using various construction materials (fiberglass, PTFE-coated fabric, etc.). The radome may also streamline the antenna system, thus reducing wind loading or drag.

The current art gives rise to a number of issues in mm-wave reflector antenna design, including the following:

a. It is difficult to couple energy from a rectangular wave guide to a circular antenna while maintaining high efficiency and suppressing cross-polarization products

b. It is difficult to manufacture the antenna using tolerances that are available with standard mass-production manufacturing techniques, that is to say the best microwave antennas that are made using mass production techniques do not achieve required levels of microwave antenna performance. This is because in general, mass production techniques provide lower tolerances than conventional designs regard as essential.

c. Microwave antennas, particularly those used in the for point-to-point communication links, are required to meet regulatory directivity radiation masks which often requires use of expensive absorbing materials.

U.S. Pat. No. 6,724,349 teaches matching, and specifically attempts to match multiple modes in order to generate a specific beam shape. All cavities are circular.

### SUMMARY OF THE INVENTION

According to a first aspect of the present invention there is provided a millimeter antenna structure comprising:

a reflector and subreflector;

a waveguide having a first end towards the reflector and subreflector, a second end and a cross-section of a second shape, say circular;

a waveguide feed having a cross section of a second shape, say rectangular;

a waveguide matching holder connected to the second end of the waveguide via a cavity of the first shape, and to the waveguide feed via a cavity of the second shape, the two cavities being shaped to merge into each other at a meeting point.

The holder may comprise a third, merging, chamber located between the first chamber and the second chamber and straddling the meeting point, the merging chamber gradually changing in cross sectional shape and size from a shape and size of the first chamber to a shape and size of the second chamber.

The first and the second chamber may be located adjacent to each other.

Alternatively, the holder may comprise a third, merging, chamber located between the first chamber and the second chamber, the merging chamber having cross-sectional shape and size different from either that of the first chamber or of the second chamber.

The waveguide holder may be milled, cast, drilled or molded.

According to a second aspect of the present invention there is provided a radome comprising a structure covering an antenna, the structure being substantially transparent to radiation of the antenna in a first direction and becoming less transparent to radiation of the antenna when deviating from the first direction, thereby imparting a directional profile to radiation of the antenna.

In an embodiment, the radome is designed for a predetermined radiation wavelength, and the structure has an electrical length, the electrical length being substantially an integer multiple of a half of the radiation wavelength in the first direction and not being an integer multiple of a half of the radiation wavelength in the second direction.

According to a second aspect of the invention there is provided a millimeter wave antenna structure comprising a sub-reflector lens, and a reflector, the sub-reflector lens comprising a reflecting metal plate and a lens shaped dielectric material connecting the reflecting metal lens plate to a waveguide, the lens shaped dielectric material and the reflecting metal plate being shaped together to provide a predetermined radiation illumination pattern on the reflector.

The reflector may be a shaped reflector, also shaped to provide the predetermined illumination pattern.

The structure may have a longitudinal axis, the sub-reflector lens being shaped and located in relation to the reflector to provide a beam exiting the reflector which is parallel with the longitudinal axis.

The structure may comprise a radome, the radome is substantially transparent to radiation of the antenna in a first direction and being of varying transparency up to substantially opaque to radiation of the antenna when deviating from the first direction, thereby imparting a directional profile to radiation of the antenna.

The radome may be designed for a predetermined radiation wavelength, and the radome may have a thickness having an electrical length, the electrical length being substantially an integer multiple of a half of the radiation wavelength in the first direction and not being an integer multiple of a half of the radiation wavelength in the second direction.

According to a third aspect of the present invention there is provided a method of manufacture of a sub-reflector lens in a millimeter wave antenna structure having a radiator and a reflector, comprising:

defining relative positions of the radiator, the reflector and the sub-reflector lens along a longitudinal axis;

carrying out ray tracing between the radiator, the sub-reflector lens and the reflector to define angles at locations on the sub-reflector lens that result in a beam emitted from the reflector that is parallel to the longitudinal axis; and

shaping the sub-reflector lens in accordance with the defined angles.

In an embodiment, the sub-reflector lens comprises a lens-shaped dielectric placed over a reflecting plate, and the ray tracing is carried out through three predefined points on the lens, an entry point for radiation from the radiator into the dielectric, a reflection point at the reflection plate and an exit point from the dielectric to the reflector.

The method may involve calculating surface tangents at the three predefined points that provide the parallel emitted beam.

The antenna structure may be for a predetermined wavelength, the method further comprising:

providing a structural covering, a radome;

machining the structural covering to have a thickness whose electrical length is an integer multiple of a half of the predetermined wavelength in a first location and whose electrical length is not an integer multiple of a half of the predetermined wavelength in at least one second location, the first and second locations being selected to provide the predetermined directional profile when the radome is fixed over the antenna.

The method may comprise manufacturing a waveguide holder by:

providing a block;

selecting a cavity design which is manufacturable from a single piece;

selecting dimensions of the design as variables using electromagnetic modeling to obtain values for the dimensions which provide cavities that retain desired radiation modes and suppress of higher order modes;

manufacturing the cavity design into the block according to the obtained values.

The term “manufacturable from a single block” refers to shapes that could physically be made by molding, casting or drilling from a single block of material, and the designer may exclude designs which would require two or more blocks of material to be physically made.

According to a further aspect of the present invention there is provided a method of manufacturing a waveguide holder for a millimeter antenna structure, the method comprising:

providing a block;

selecting a cavity design which is manufacturable from a single piece;

selecting dimensions of the design as variables

using electromagnetic modeling to obtain values for the dimensions which provide cavities that retain desired radiation modes and suppress of higher order modes;

manufacturing the cavity design into the block according to the obtained values.

The cavity design may be manufactured by one member of the group of manufacturing techniques including milling, casting and molding.

The cavity design may comprise:

a rectangular cavity for receiving a rectangular waveguide feed at a first end of the block;

a circular cavity for receiving a circular waveguide at a second end of the block; and

a merging of the rectangular cavity into the circular cavity.

The antenna structure may be built or intended for a predetermined wavelength, the method further comprising:

providing a structural covering;

machining the structural covering to have a thickness whose electrical length is an integer multiple of a half of the predetermined wavelength in a first location and whose electrical length is not an integer multiple of a half of the predetermined wavelength in at least one second location, the first and second locations being selected to provide the predetermined directional profile when the radome is fixed over the antenna.

According to a further aspect of the present invention there is provided a method of manufacturing a radome for an antenna intended to transmit at a predetermined wavelength with a predetermined directional profile, the method comprising:

providing a structural covering;

machining the structural covering to have a thickness whose electrical length is an integer multiple of a half of the predetermined wavelength in a first location and whose electrical length is not an integer multiple of a half of the predetermined wavelength in at least one second location, the first and second locations being selected to provide the predetermined directional profile when the radome is fixed over the antenna.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing an exploded view of an antenna according to the present embodiments;

FIG. 2A is a simplified diagram showing a first embodiment of a waveguide holder in both two and three dimensions, according to the present invention;

FIG. 2B is a simplified diagram showing a second embodiment of a waveguide holder in both two and three dimensions, according to the present invention;

FIG. 2C is a simplified diagram showing a third embodiment of a waveguide holder according to the present invention, shown in both two and three dimensions;

FIG. 3 is a simplified diagram showing a subreflector module attached to the waveguide holder and waveguide in both two and three dimensions, according to an embodiment of the present invention;

FIG. 4 is a simplified diagram schematically showing how directionality can be built into the structure of a radome by varying the thickness of the radome shell;

FIG. 5 is a simplified flow chart illustrating steps in the design and manufacture of a waveguide holder according to the present embodiments.

FIG. 6 is a schematic illustration of a waveguide holder structure being selected in the process of FIG. 5;

FIG. 7 is a schematic illustration of variables applied to the structure of FIG. 6 and according to the process of FIG. 5;

FIG. 8 is a simplified diagram illustrating points in the subreflector whose angles are selected in the process of shaping the subreflector according to an embodiment of the present invention;

FIG. 9 illustrates in greater detail the selection of an angle at the point A in FIG. 8;

FIG. 10 illustrates in greater detail the selection of an angle at the point B in FIG. 8;

FIG. 11 is a simplified diagram illustrating the procedure of shaping the subreflector by calculation of angles at the specified points A, B and C using ray tracing; and

FIG. 12 illustrates an assembled microwave antenna according to embodiments of the present invention.

### DESCRIPTION OF THE PREFERRED EMBODIMENTS

The present embodiments comprise a reflector antenna and may include an associated radome. In some embodiments, the antenna is for millimeter wavelengths.

In one embodiment of the present invention the radome differs from a conventional radome in that, instead of being transparent to radiation in all directions, the radome is transparent to radiation in a desired direction or in accordance with a desired directional profile of the beam. The radome thus imposes the desired directional profile on the antenna beam.

The radiation pattern, or directional profile of the radiation may be enhanced by making parts of the radome of a thickness having an electrical length which is an integer multiple of a half of the transmitted wavelength. Other parts of the radome are of thicknesses whose electrical lengths are not integer multiples thereof. Thus the radome is transparent to the radiation wherever the thickness is an integer multiple and is less transparent wherever the thickness is not an integer multiple. By selecting regions of the radome to apply the particular thicknesses, directional profiles may be enhanced simply and cheaply.

There is further provided a shaping of cavities in a waveguide holder so that the holder can hold a rectangular waveguide feed at one end and a circular waveguide feed at the other end, with gradual merging of the shapes from rectangular to circular waveguide in a way that minimizes losses and is easy to manufacture.

There is provided a method for manufacturing the feed with high accuracy and at low cost.

There is furthermore provided the use and structure of a lens sub-reflector more specifically—a combination of shaped lens and sub-reflector. The shapes are modified, by trial and error or by simulation, using optical ray tracing, to meet a specific illumination pattern.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Reflector Antenna for mm-Wave Frequencies

The present embodiments may provide a circular reflector antenna for mm-wave, or microwave, frequencies that is in general directly fed from a standard rectangular wave guide. The antenna of the present embodiments includes a feed design which may provide good RF performance when made using standard mass-production manufacturing techniques such as milling or die-casting, as will be discussed below. The antenna may also make use of a shaped radome to meet gain directivity requirements.

The present embodiments address issues in mm-wave reflector antenna design, including the following:

a. How to couple energy from a non circular, for example rectangular, wave guide to a circular antenna while maintaining high efficiency and suppressing cross-polarization products

b. How to enable manufacturing the antenna using tolerances that allow manufacturing using standard mass-production manufacturing techniques, that is to say it addresses the issue of how to achieve required levels of microwave antenna performance when using mass production manufacturing techniques. Generally the mass production techniques provide lower tolerances than conventional designs regard as essential.

c. The present embodiments meet regulatory directivity radiation masks by utilizing shaping of the radome, and also shaping of the sub-reflector, in place of the prior art method of using expensive absorbing materials or requiring expensive, very high mechanical accuracy.

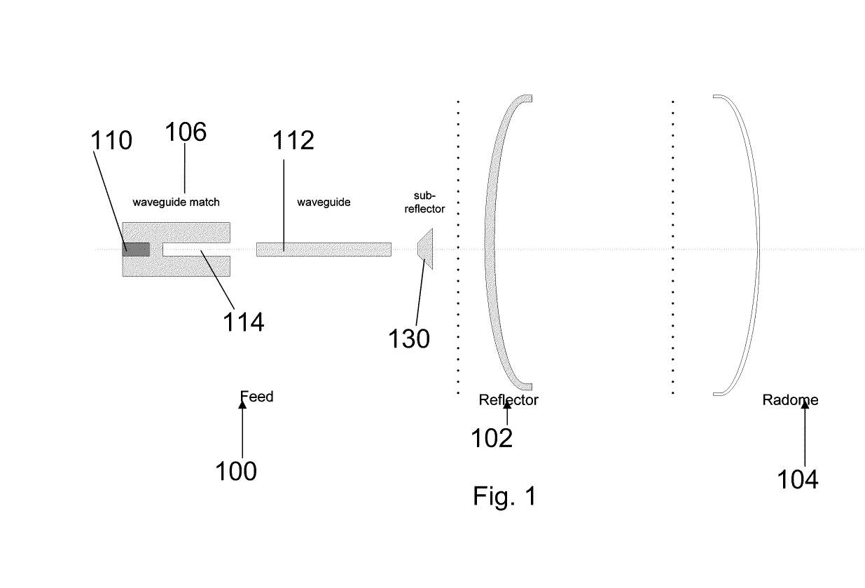

With reference to FIG. 1, there is provided a radome, a structure covering an antenna, the structure being substantially transparent to radiation of the antenna in a first direction and being less transparent to radiation of the antenna in other directions, that is when deviating from the first direction, thereby imparting a directional profile to radiation of the antenna. The millimeter wave antenna structure comprises a sub-reflector lens, and a reflector, the sub-reflector lens in turn comprising a reflecting metal plate and a lens shaped dielectric material, the lens shaped dielectric material and the reflecting metal plate being shaped together to provide a predetermined radiation illumination pattern on the reflector. A waveguide matching holder connects a circular cross section waveguide via a circular cavity, and a rectangular waveguide feed via a rectangular cavity, the rectangular and the circular cavities being shaped to merge into each other.

More particularly, the antenna consists of three parts, namely a feed module 100, a reflector 102 and a radome 104. As will be explained, the feed part is built in a manner in the present embodiments that allows for low cost mass production techniques.

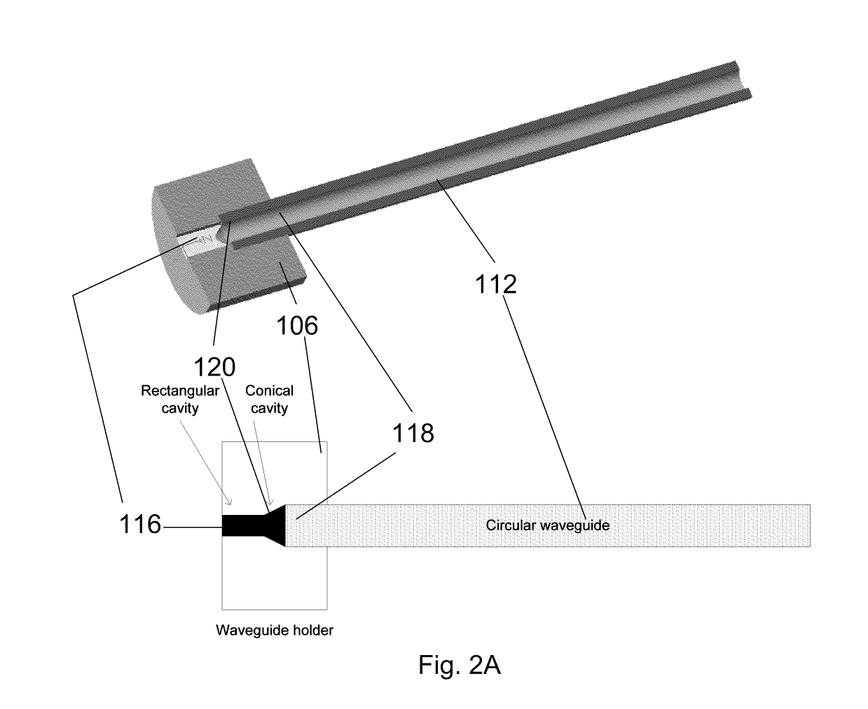

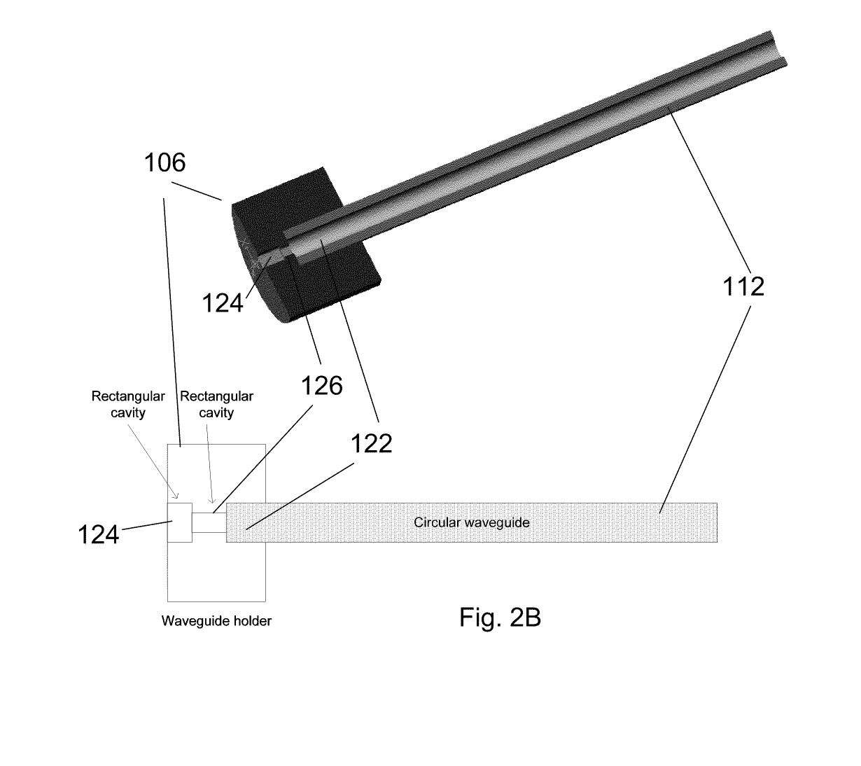

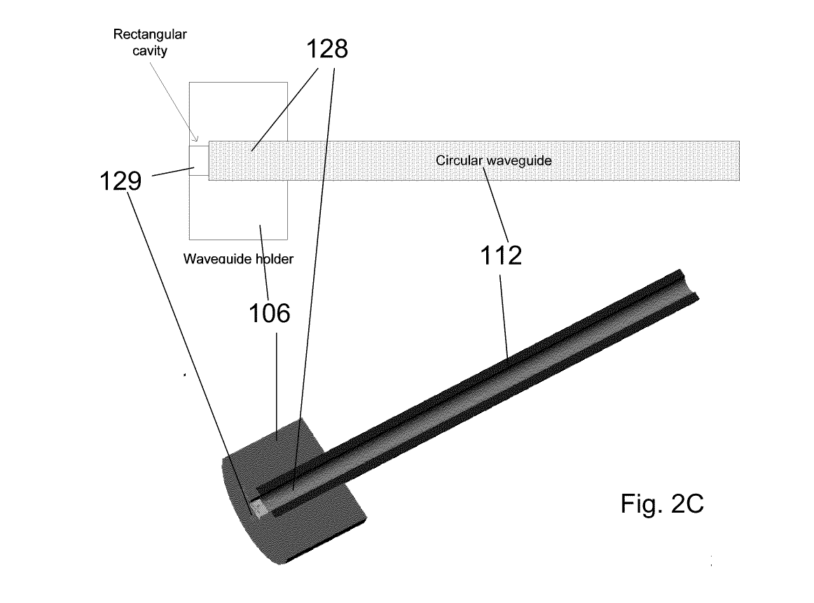

The feed module 100 itself consists of three parts where the first part is a waveguide holder 106, also referred to as waveguide match, containing a matching cavity 110. The matching cavity 110 is shaped to allow a standard rectangular waveguide to be attached to the outer face of cavity 110, and a circular feed waveguide 112 to be inserted at the opposite end 114. A connection may thus be made within the waveguide holder 106 between a standard rectangular waveguide and a circular waveguide. The matching cavity 110 is responsible for suppression of cross polarization products and undesired propagation modes. Various possible shapes for the cavity are depicted in FIGS. 2A to 2C, each of which show the waveguide holder 106 and the circular feed wave guide 112 it holds.

FIG. 2A shows, in three dimensions above and two dimensions below, a rectangular cavity 116 which is of smaller cross section than the circular cavity 118. A conical cavity 120 serves as a bridging or matching cavity between the two.

FIG. 2B shows, in three dimensions above and two dimensions below, a rectangular cavity 124 at one end of waveguide holder 106, a circular cavity 122 of similar sized cross section at the opposite end of waveguide holder 106 and the circular feed wave guide 112 it holds, and a rectangular internal waveguide cavity 126 linking between the rectangular cavity 124 and the circular cavity 122. The internal rectangular cavity 126 is of smaller transverse cross sectional size than either of the external cavities 122 and 124.

FIG. 2C shows, in both two and three dimensions, an embodiment in which rectangular cavity 129 leads directly to the circular cavity 128 and the circular feed wave guide 112 it holds, the rectangular cavity being of a smaller cross-section.

Indeed the waveguide holder, or more precisely the cavities within the holder, serve to match between the rectangular part and round part. The precise dimensions of the cavities may be provided using EM simulation to find cases in which higher order modes and cross-polarization modes are suppressed, while the desired mode is allowed to pass.

A linking feature of all the examples above is that the waveguide cavity is designed such that it may be molded as one piece, molded and milled, or just milled. Whilst many specific configurations may be found by EM simulation, the structures that are preferred are those that are easy to manufacture.

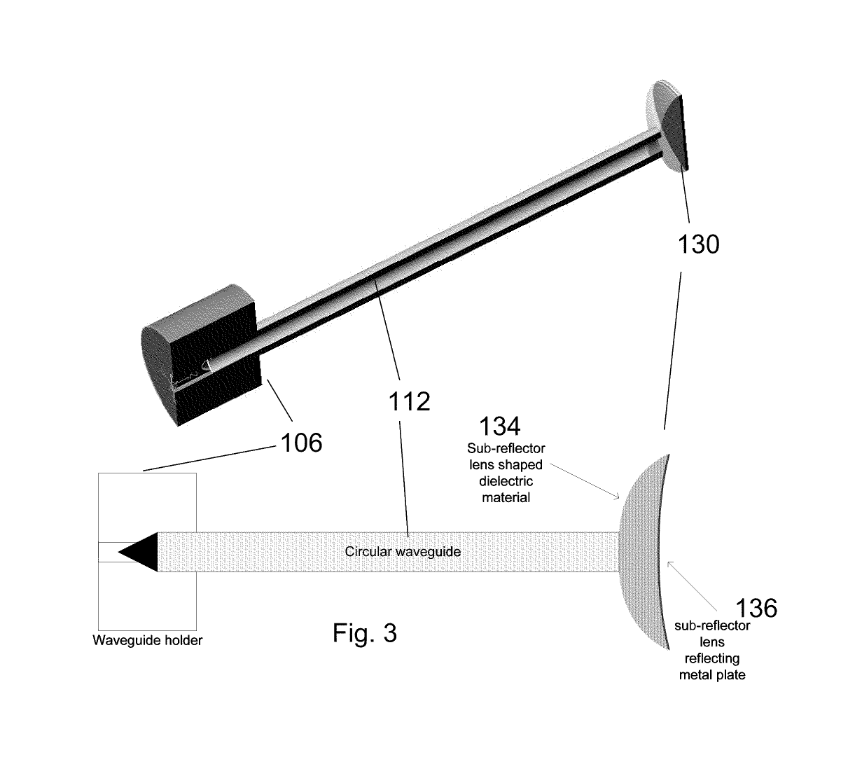

Reference is now made to FIG. 3. The waveguide holder 106 holds a section of circular waveguide 112, which in turn supports sub-reflector lens module 130. The three feed parts, namely the waveguide holder 106, the waveguide 112 and the sub-reflector lens module 130, require very high precision in their dimensions, in the order of 0.01 mm to 0.05 mm. The specific construction of the feed from the three parts as shown, makes it easier to meet the tight tolerances for each part, and each of the parts may be manufactured using the manufacturing technology that is best suited to its specific geometry.

The sub-reflector lens module 130 is mounted on the waveguide 112. The lens may be composed of a dielectric material 134 and a reflecting metal, or metal coated, plate 136. The shapes of the dielectric material 134 and plate 136 are designed such that sub-reflector lens shaped dielectric material 134 and sub-reflector lens being a reflecting metal plate 136 between them modify the radiated elector-magnetic field from the feed and reflect it to generate a required pattern on the reflector 102 (FIG. 1), such that the antenna may meet the required antenna directivity and side-lobe suppression requirement. The reflector 102(FIG. 1) may also be shaped to provide the desired pattern. The pattern is a radiation pattern and may be considered in the same way as an illumination pattern.

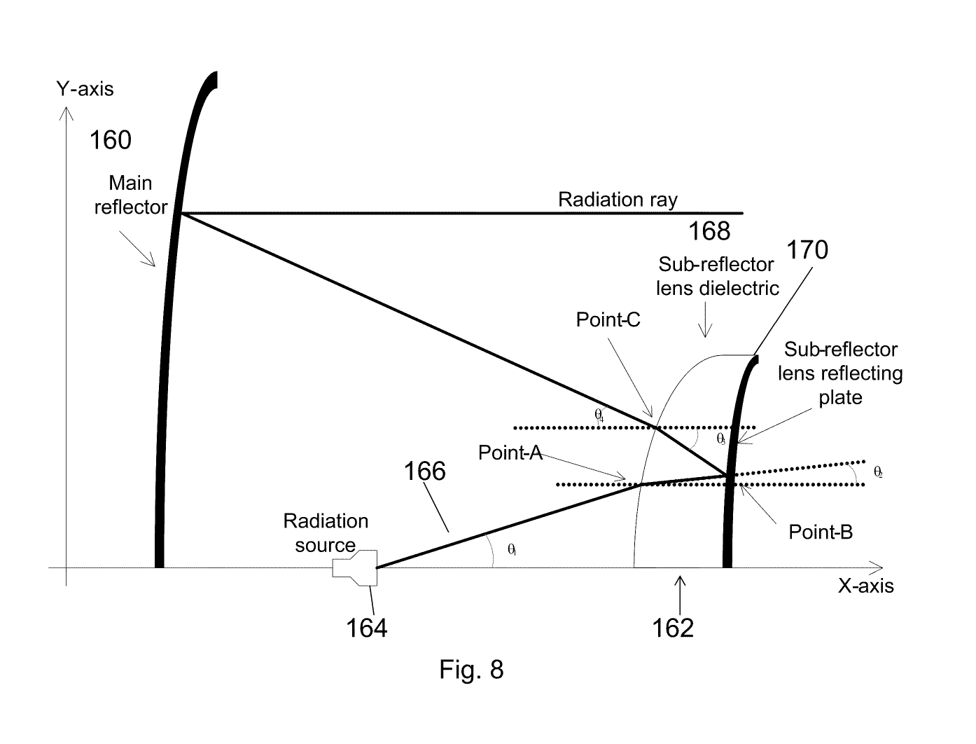

There is thus provided a combination of a shaped reflector and shaped dielectric material, in which the specific shaping of the two parts is designed to meet a certain design goal of illumination. A process for shaping is discussed in greater detail with respect to FIGS. 8 to 12.

Considering again FIG. 1, the entire feed module 100 may be mated with the reflector 102, which in turn is mated with the shaped radome 104.

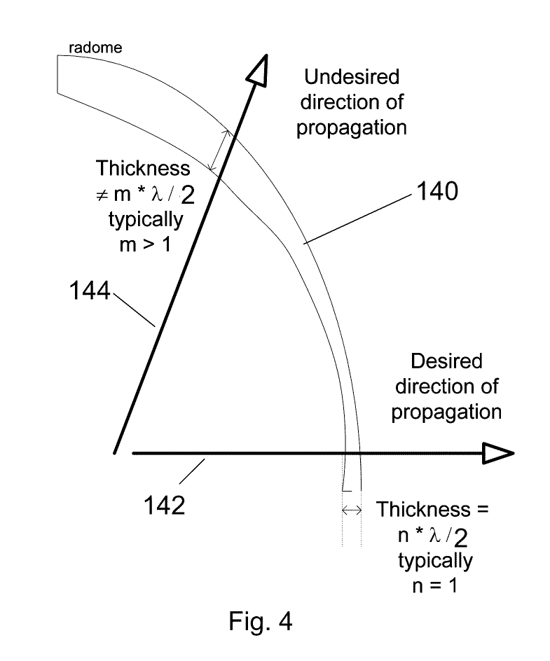

Reference is now made to FIG. 4 which concerns the shaping of the radome. The radome structure comprises a shell 140 of varying thickness. Arrow 142 indicates a desired direction of radiation propagation. Arrow 144 indicates an undesired direction of radiation propagation.

The shape of the radome is designed such that along the required direction of propagation 142 the electrical length, in the thickness of the shell 140, as determined by its dielectric constant and the frequency of operation may be an integer multiple of a half wavelength. Along any un-desired direction of propagation, such as direction 144, the radome is built so that its thickness does not follow this rule, and as a result the radome material has increased absorption and reflection (and thus decreased transmission) in the non-desired direction of propagation.

An application of the present embodiments consists in enabling the construction of very low-cost antennas for use in mm-wave point-to-point communication links

The following discusses the general design steps of the feed cavity in greater detail and provides a specific example based on above FIG. 2A having a rectangular cavity for the waveguide feed and a conical matching cavity.

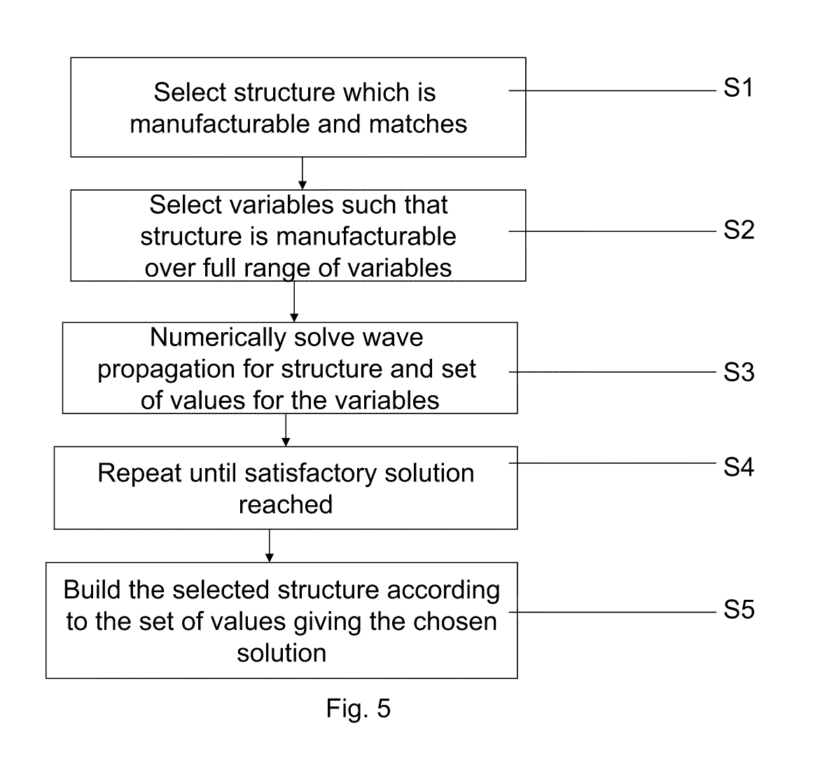

FIG. 5 illustrates a simplified manufacturing process.

S1. Select a cavity structure which is manufacturable preferably using low-cost manufacturing techniques and tolerances, and believed to be able to match between the waveguides, meaning that energy is transferred across the structure with maximal efficiency and minimal attenuation. In particular such efficient transmission applies to desired modes. Undesired modes may nevertheless be suppressed.

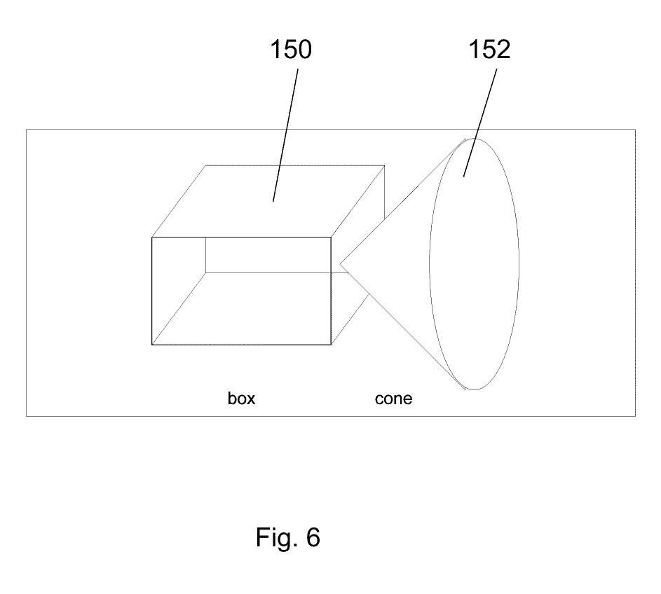

Example: Select a cavity composed of a rectangular section, a box, 150 and a conical section, a cone, 152 as shown in FIG. 6. This cavity is manufacturable by either milling or casting/molding.

S2. Define the structure such that some of its attributes are variables, the attributes allowed to vary being such as length, diameter, depth, slope, etc. The variables and their allowed ranges are selected such that the structure is manufacturable across the entire variables range.

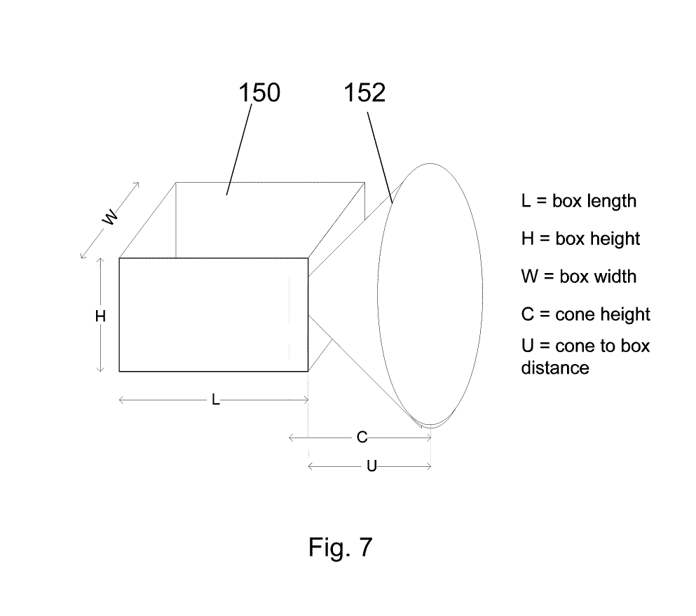

Example: In the box and cone case we select the dimensions of the box, the height of the cone and the distance from the cone base to the box, a total of five variables as shown in FIG. 7.

S3. Numerically solve the wave propagation problem with a given set of values to our previously defined parameters. Several methods of solving will be apparent to the skilled person and the exact method of solving does not matter. The assigned values would typically relate to the wave guides being matched, and to the wavelength of the problem.

Numerical Example: In the box and cone case we attempt to match a rectangular wave guide having a rectangular cross-section of 3.96 mm×1.88 mm and a circular waveguide having a diameter of 3.5 mm. The wavelength is 4.1 mm. We may select W=3.9 mm, H=1.9 mm (to match more or less the waveguide rectangular cross section). We further select L=4.1 mm (one wavelength) and U=1 mm (about a quarter wavelength). We also select C=0.5 mm (cone half way inserted into the box).

S4. Repeat step 3 for various other sets of values assigned to our variables. The values may be assigned in various ways, for example a scan of a range of values, or based on an optimization method (e.g. steepest descent).

S5. Once a set of values leads to a solution to the problem that is satisfactory in terms of the resulting match between the waveguides, we get a structure which is manufacturable.

Numerical Example: In the cone and box case, a search of the best match yields the following values:

W=3.76 mm,H=1.88 mm,L=8 mm,U=0 mm,C=4 mm

The following describes in greater details the sub-reflector lens design methodology.

In general, in order to determine the exact antenna radiation pattern of a certain combination of feed, lens, sub-reflector and reflector one would have to solve Maxwell equations numerically. Since this solution is computationally costly, the described method attempts to get sufficiently close to the solution by using approximations. The basic approximation used is that of geometrical optics (GO). Under this approximation we treat the illuminating feed as a radiation source with a given intensity distribution across its surface (which for further simplicity may be regarded as a point source). Further, we treat the reflector and sub-reflector as ideal reflecting minors, and we treat the dielectric material as an ideal transparent dielectric with a given coefficient of refraction.

Using these approximations we can, based on the shape of the sub-reflector and lens, trace each ray from the radiation source and determine the angles and the positions at which it would hit the reflector, sub-reflector and lens. This ray tracing technique enables synthesizing a desired radiation pattern on the reflector by shaping the lens and the sub reflector surfaces. FIG. 8 shows the main reflector the sub-reflector lens 162 and a radiation source 164. The main reflector 160 here is equivalent to reflector 102 in FIG. 1. The radiation source 164 emits a ray, 166, whose path is traced as it passes through dielectric material 168 and as it is reflected from the sub-reflector reflecting plate 170 and the main reflector 160. The points A, B and C are the points where the ray direction is changed due to refraction in the dielectric material, or reflection by the reflecting plate. The angles θ₁ through θ₄ represent the angle between the ray direction and the x-axis.

The assumptions used in the analysis are:

1. The profiles of all surfaces manipulating the ray are either convex or concave. An analysis is still possible if they are not, but in such a case, the offending profile, that is the profile not being either convex or concave, may be split into two sections where each of the separate sections do meet the condition of being convex or concave.

2. The dielectric lens material can be divided into two independent sections, represented by point-A and point-C. There is an angle θ_{MAX}, that defines Y_{MAX} for point-A. Any radiation sourced from the radiation source, which hits point-C at height below Y_{MAX}, will be blocked and not reach the main reflector.

3. Reflections by the dielectric material are assumed small enough to be ignored.

Under the assumptions above, it can be shown that the ray path 166 may be controlled to create a desired illumination pattern on the reflector. Assume we start with a radiation source with a given angular intensity pattern I(θ). All rays emitted in an angle dθ₁ centered on direction θ₁ will hit point-A at a section of width dy₁ centered around height y₁. We may shape the surface of the lens dielectric at point-A, such that the refracted ray may hit a section of width dy₂ centered around height y₂ on the sub-reflector reflecting plate. This choice of shaping enables arbitrarily designing the illumination pattern on the sub-reflector reflecting plate and determining the angle θ₂ for the ray.

All rays hitting the sub-reflector reflecting plate in the section of width dy₂ centered around height y₂ are reflected at an angle dθ₃ centered in direction θ₃ and hit point-C at a section of width dy₃ centered around height y₃. The reflecting plate may be shaped to arbitrarily determine θ₃. All rays hitting point-C on an angle dθ₃ centered in direction θ₃ hit the main reflector at a section of width dy₄ centered around height y₄. The present embodiments involve shaping the surface of the lens dielectric at point-C, such that the refracted ray may hit the main reflector at a height and an angle that ensures its reflection parallel to the x-axis, based on the main reflector shape, which would typically be a parabola.

We now may proceed to define geometrical relations that enable determining the shape profile of the sub-reflector lens and sub-reflector reflecting plate. We may designate each profile using radial coordinates as ρₓ(θ), where X is either A, B or C, to represent the shape at points A, B and C respectively.

Step 1 (point A):

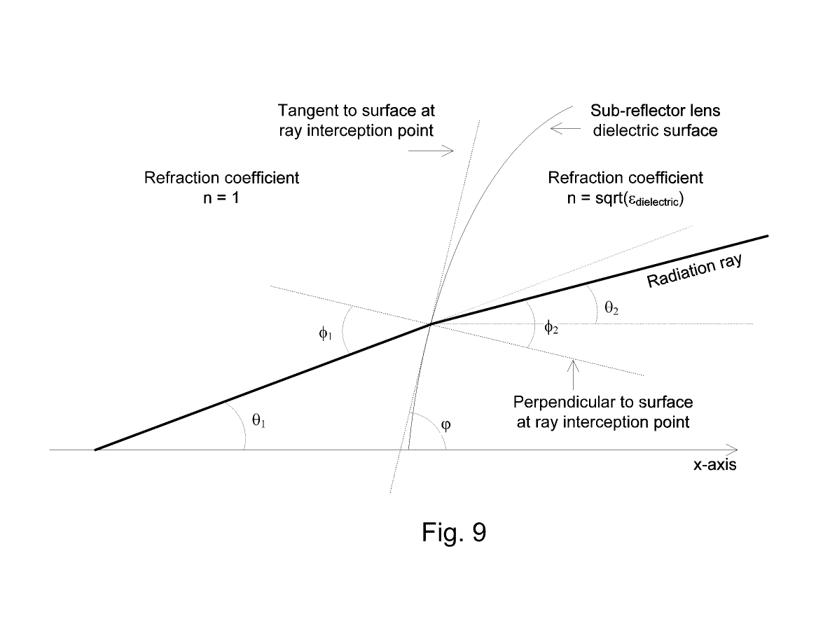

The geometry of the sub-reflector lens at point-A is shown in FIG. 9

From applying Snell's law we obtain

$$\frac{sin ( {φ}_{1} )}{sin ( {φ}_{2} )} = \sqrt{{ɛ}_{d}}$$

If the dielectric surface profile ρ_{A}(θ) is described in Cartesian coordinates as y_{A}(x), then the tangent to the surface would be at an angle φ where

$$ϕ = arctan ( \frac{d {y}_{A}}{d x} )$$

at the intercept point. This may also be expressed in radial coordinates by

$$tan ϕ = \frac{sin ϕ}{cos ϕ} = \frac{{ρ}_{A}^{′} ( θ ) \cdot sin ( θ ) + {ρ}_{A} ( θ ) \cdot cos ( θ )}{{ρ}_{A}^{′} ( θ ) \cdot cos ( θ ) - {ρ}_{A} ( θ ) \cdot sin ( θ )} \\ where \\ {ρ}_{A}^{′} = \frac{d {ρ}_{A}}{d θ} \qquad [ 1 ]$$

From the geometry of the problem we observe that φ₁=90+θ₁−φ and φ₂90+θ₂−φ

This can be substituted in Snell's law to yield the relation between θ₁ and θ₂

$$\frac{cos ( {θ}_{1} - ϕ )}{cos ( {θ}_{2} - ϕ )} = \frac{cos {θ}_{1} \cdot cos ϕ + sin {θ}_{1} \cdot sin ϕ}{cos {θ}_{2} \cdot cos ϕ + sin {θ}_{2} \cdot sin ϕ} = \sqrt{{ɛ}_{d}}$$

which may be expressed also as

$$tan ϕ = \frac{cos {θ}_{1} - \sqrt{{ɛ}_{d}} \cdot cos {θ}_{2}}{\sqrt{{ɛ}_{d}} \cdot sin {θ}_{2} - sin {θ}_{1}} \qquad [ 2 ]$$

As our purpose is to shape the dielectric surface such that a ray hitting a point y₁ will hit the reflector at point y₂, we can use the information about the distance between the ray source and the lens surface, and the distance between the lens surface and the reflector surface, to define the desired functional relationship θ₂=f_{A}(θ₁). Using equations [1] and [2] above, we may obtain a differential equation for the required dielectric surface profile shape, ρ_{A}(θ)

$$\frac{cos θ - \sqrt{{ɛ}_{d}} \cdot cos ( {f}_{A} ( θ ) )}{\sqrt{{ɛ}_{d}} \cdot sin ( {f}_{A} ( θ ) ) - sin θ} = \frac{{ρ}_{A}^{′} ( θ ) \cdot sin ( θ ) + {ρ}_{A} ( θ ) \cdot cos ( θ )}{{ρ}_{A}^{′} ( θ ) \cdot cos ( θ ) - {ρ}_{A} ( θ ) \cdot sin ( θ )} \qquad [ 3 ]$$

Equation [3] can be numerically or analytically solved in order to find ρ_{A}(θ) that would result in refraction that would yield the desired intensity distribution on the sub-reflector metal plate.

Step 2 (point B):

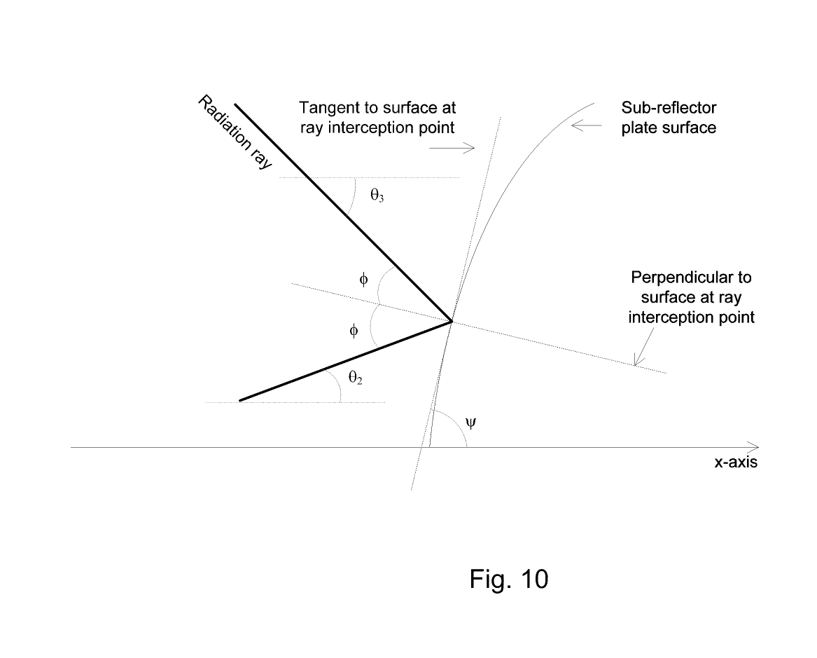

The geometry at point-B on the sub-reflector lens is shown in FIG. 10,

If the reflecting plate surface profile ρ_{B}(θ) is be described in Cartesian coordinates as y_{B}(x), then the tangent to the surface may be at an angle ψ where

$$ψ = arctan ( \frac{d {y}_{B}}{d x} )$$

at the intercept point. This may also be expressed in radial coordinates by

$$tan ψ = \frac{sin ψ}{cos ψ} = \frac{{ρ}_{B}^{′} ( θ ) \cdot sin ( θ ) + {ρ}_{B} ( θ ) \cdot cos ( θ )}{{ρ}_{B}^{′} ( θ ) \cdot cos ( θ ) - {ρ}_{B} ( θ ) \cdot sin ( θ )} \\ where \\ {ρ}_{B}^{′} = \frac{d {ρ}_{B}}{d θ} \qquad [ 4 ]$$

From the previous step and the information about the distance between the dielectric lens surface, and the reflector plate surface, one can estimate the intercept point with the reflector plate, and express θ₂ in radial coordinates as θ₂(θ). From the geometry of the problem we observe that φ=90+θ₂−ψ and φ=θ₃+ψ−90. As our purpose is to shape the reflecting plate surface such that a ray hitting at angle θ₂ will hit the dielectric surface at angle θ₃, we can define the desired functional relationship θ₃=f_{B}(θ₂). Using equation [4] above, we may obtain a differential equation for the required dielectric surface profile shape, ρ_{B}(θ)

$$tan ( \frac{180 + {θ}_{2} ( θ ) - {f}_{B} ( {θ}_{2} ( θ ) )}{2} ) = \frac{{ρ}_{B}^{′} ( θ ) \cdot sin ( θ ) + {ρ}_{B} ( θ ) \cdot cos ( θ )}{{ρ}_{B}^{′} ( θ ) \cdot cos ( θ ) - {ρ}_{B} ( θ ) \cdot sin ( θ )} \qquad [ 5 ]$$

Equation [5] can be numerically or analytically solved in order to find ρ_{B}(θ) that would result in the a reflection that would yield the angular distribution on the sub-reflector dielectric surface.

Step 3 (point C):

This step is essentially similar to step 1 (the same geometry applies) with the difference that this time the ray is traveling from the direction of the dielectric and into the air. Since the geometry is the same, we may write similar equations, and define the functional relationship θ₄=f_{C}(θ₃) that yields the desired illumination pattern. If we express θ₃ in radial coordinates as θ₃(θ) we may write

$$\frac{cos ( {f}_{C} ( {θ}_{3} ( θ ) ) ) - \sqrt{{ɛ}_{d}} \cdot cos ( {θ}_{3} ( θ ) )}{\sqrt{{ɛ}_{d}} \cdot sin ( {θ}_{3} ( θ ) ) - sin ( {f}_{c} ( {θ}_{3} ( θ ) ) )} = \frac{{ρ}_{C}^{′} ( θ ) \cdot sin ( θ ) + {ρ}_{C} ( θ ) \cdot cos ( θ )}{{ρ}_{C}^{′} ( θ ) \cdot cos ( θ ) - {ρ}_{C} ( θ ) \cdot sin ( θ )} \qquad [ 6 ]$$

Equation [6] can be numerically or analytically solved in order to find ρ_{C}(θ) that would result in the a refraction that would yield the desired intensity distribution on the main reflector surface.

The above equations enable us to determine the structure under the GO approximation. After the GO part is finished, the next step would be to test the result by solving Maxwell equations more accurately and observing the result. Assuming that the GO solution is close enough, we should get an illumination pattern close to the desired one. The performance of the solution can be further optimized by methodically effecting small changes to the lens/sub-reflector shapes and observing which of these changes brings us closer to the desired illumination pattern.

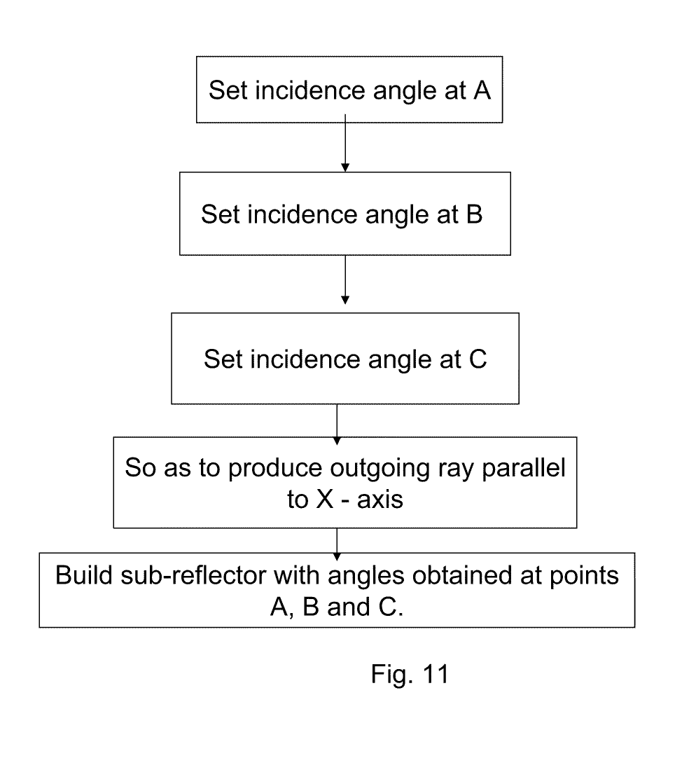

The corresponding design process for setting the illumination pattern is illustrated in flow chart FIG. 11. The angles that the beam is to strike at the three locations A, B and C are determined according to the equations above and with an overall aim of producing an outward beam being parallel to the X axis. A subreflector is then built to set up the illumination pattern so as to provide the beam at the determined angles at each of the points A, B and C.

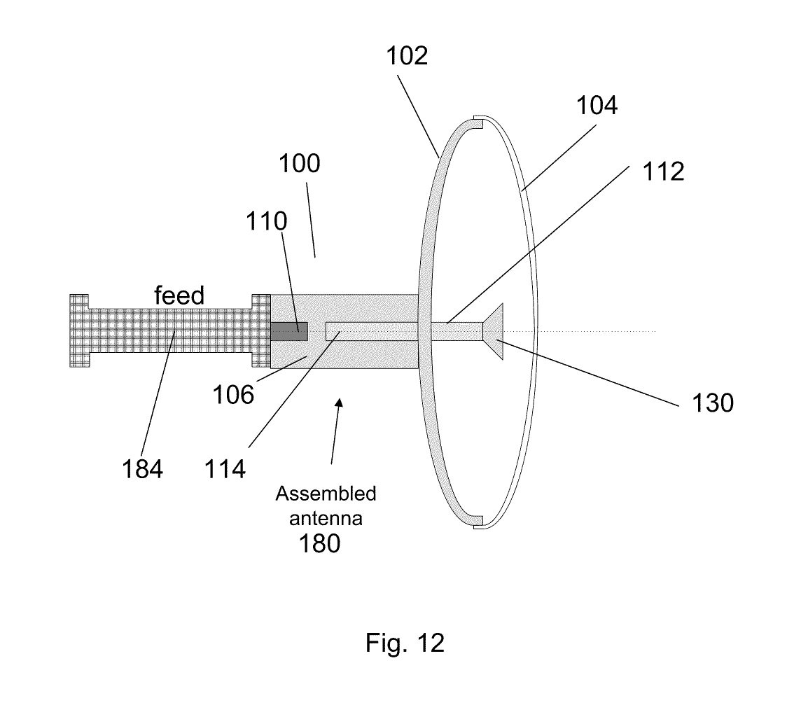

Reference is now made to FIG. 12 which is a schematic illustration of the assembled antenna 180. Parts are partially as numbered in FIG. 1, and in other cases numbered anew. Rectangular waveguide feed 184 is attached to rectangular cavity 110 on the left of the waveguide holder 106. Circular waveguide 112 is held in circular cavity 114 and extends to sub-reflector 130. Sub-reflector 130 reflects radiation backwards to the main reflector 102 and then through the radome 104. The shaping of the sub-reflector gives a certain shape profile to the radiation which is reinforced by the shaping of the main reflector 102 and the radome 104. Between the three the directional profile is achieved for very little energy loss.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A millimeter antenna structure comprising:
a reflector and subreflector;
a waveguide having a first end towards said reflector and subreflector, a second end and a cross-section of a first shape;
a waveguide feed having a cross section of a second shape;
a waveguide matching holder connected to said second end of said waveguide via a cavity of said first shape, and to said waveguide feed via a cavity of said second shape, said cavity of said first shape and said cavity of said second shape having a meeting point at which they are shaped to merge into each other.

2. The millimeter antenna structure of claim 1, wherein said holder comprises a third, merging, chamber located to straddle said meeting point between said first chamber and said second chamber, said merging chamber gradually changing in cross sectional shape and size from said first shape and a size of said first chamber to said second shape and a size of said second chamber.

3. The millimeter antenna structure of claim 1, wherein said first and said second chamber are located adjacent to each other.

4. The millimeter antenna structure of claim 1 wherein said holder comprises a third, merging, chamber straddling said meeting point between said first chamber and said second chamber, said merging chamber having cross-sectional shape and size different from either that of said first chamber or of said second chamber.

5. The millimeter antenna structure of claim 1, wherein said waveguide holder is milled, cast or molded.

6. The millimeter antenna structure of claim 1, wherein said first shape is circular and said second shape is rectangular.

7. A radome comprising a structure covering an antenna, the structure being substantially transparent to radiation of said antenna in a first direction and being of reduced transparency to radiation of said antenna on deviation from said first direction, thereby imparting a directional profile to radiation of said antenna.

8. The radome of claim 7, wherein said transparency changes gradually with said deviation.

9. The radome of claim 7, wherein said antenna has a predetermined radiation wavelength, and said structure has an electrical length, said electrical length being substantially an integer multiple of a half of said radiation wavelength in said first direction and not being an integer multiple of a half of said radiation wavelength on deviation from said first direction.

10. A millimeter wave antenna structure comprising a sub-reflector lens, and a reflector, the sub-reflector lens comprising a reflecting metal plate and a lens shaped dielectric material connecting said reflecting metal lens plate to a waveguide, the lens shaped dielectric material and said reflecting metal plate being shaped together to provide a predetermined radiation illumination pattern on said reflector.

11. The millimeter wave antenna structure of claim 10, wherein said reflector is a shaped reflector, also shaped to provide said predetermined illumination pattern.

12. The millimeter wave antenna structure of claim 10, having a longitudinal axis and wherein said sub-reflector lens is shaped and located in relation to said reflector to provide a beam exiting said reflector which is parallel with said longitudinal axis.

13. The millimeter wave antenna structure of claim 10, further comprising a radome, the radome substantially transparent to radiation of said antenna in a first direction and being of reduced transparency when deviating from the first direction, thereby imparting a directional profile to radiation of said antenna.

14. The structure of claim 13, wherein said antenna has a predetermined radiation wavelength, and said radome has a thickness having an electrical length, said electrical length being substantially an integer multiple of a half of said radiation wavelength in said first direction and not being an integer multiple of a half of said radiation wavelength in said second direction.

15. A method of manufacture of a sub-reflector lens in a millimeter wave antenna structure having a radiator and a reflector, comprising:
defining relative positions of said radiator, said reflector and said sub-reflector lens along a longitudinal axis;
carrying out ray tracing between said radiator, said sub-reflector lens and said reflector to define angles at locations on said sub-reflector lens that result in a beam emitted from said reflector that is parallel to said longitudinal axis; and
manufacturing said sub-reflector lens by shaping said sub-reflector lens in accordance with said defined angles.

16. The method of claim 15, wherein said sub-reflector lens comprises a lens-shaped dielectric placed over a reflecting plate, and said ray tracing is carried out through three predefined points on said lens, an entry point for radiation from said radiator into said dielectric, a reflection point at said reflection plate and an exit point from said dielectric to said reflector.

17. The method of claim 16, comprising calculating surface tangents at said three predefined points that provide said parallel emitted beam.

18. The method of claim 17, further comprising using said surface tangents as a first approximation and then finding an improved accuracy beam path by solving Maxwell's equations.

19. The method of claim 15, wherein the antenna structure is for a predetermined wavelength, the method further comprising:
providing a structural covering;
machining said structural covering to have a thickness whose electrical length is an integer multiple of a half of said predetermined wavelength in a first direction and whose electrical length is not an integer multiple of a half of said predetermined wavelength in at least one second direction, said first and second directions being selected to provide said predetermined directional profile when said structural covering is fixed over said antenna.

20. The method of claim 15, further comprising manufacturing a waveguide holder by:
providing a block;
selecting a cavity design which is manufacturable from a single block;
selecting dimensions of said design as variables
using electromagnetic modeling to obtain values for said dimensions which provide cavities that retain desired radiation modes and suppress undesired radiation modes;
manufacturing said cavity design into said block according to said obtained values.

21. A method of manufacturing a waveguide holder for a millimeter antenna structure, the method comprising:
providing a block;
selecting a cavity design which is manufacturable from a single block
selecting dimensions of said design as variables
using electromagnetic modeling to obtain values for said dimensions which provide cavities that retain desired radiation modes and suppress undesired radiation modes;
manufacturing said cavity design into said block according to said obtained values.

22. The method of claim 21, wherein said cavity design is manufactured by at least one member of the group of manufacturing techniques including milling, casting and molding.

23. The method of claim 21 wherein said cavity design comprises:
a cavity of a first cross-sectional shape for receiving a waveguide feed of said first cross-sectional shape at a first end of said block; and
a cavity of a second cross-sectional shape for receiving a waveguide of said second cross-sectional shape at a second end of said block; and
a merging of said cavity of said first cross-sectional shape into said cavity of said second cross-sectional shape.

24. The method of claim 21, the antenna structure being built for a predetermined wavelength, the method further comprising:
providing a structural covering;
machining said structural covering to have a thickness whose electrical length is an integer multiple of a half of said predetermined wavelength in a first direction and whose electrical length is not an integer multiple of said half of predetermined wavelength in at least one second direction, said first and second directions being selected to provide said predetermined directional profile when said structural covering is fixed over said antenna.

25. A method of manufacturing a radome for an antenna intended to transmit at a predetermined wavelength with a predetermined directional profile, the method comprising:
providing a structural covering to form said radome;
machining said structural covering to have a thickness whose electrical length is an integer multiple of a half of said predetermined wavelength in a first direction and whose electrical length is not an integer multiple of half of said predetermined wavelength in at least one second direction, said first and second directions being selected to provide said predetermined directional profile when said radome is fixed over said antenna.
